(19) United States
(12) Patent Application Publication
(10) Pub. No.: US 2005/0198177 A1
(43) Pub. Date: Sep. 8, 2005

(54) Opting out of spam

(76) Inventor: Steve Black, Orem, UT (US)

Correspondence Address: THORPE NORTH & WESTERN, LLP., 8180 SOUTH 700 EAST, SUITE 200, P.O. BOX 1219, SANDY, UT, 84070, US

(21) Appl. No.: 11/039,356

(22) Filed: Jan. 18, 2005

Related U.S. Application Data
(60) Provisional application No. 60/538,885, filed on Jan. 23, 2004.

(51) Int. Cl. G06F 15/16

(52) U.S. Cl. 709/206; 705/14

(57) ABSTRACT

A method for dealing with unwanted email advertising, having at least two of the following steps: a. automatically opting-out of unwanted email advertising; b. forwarding unwanted email advertising to a service which opts-out users; c. forwarding unwanted email advertising to a service which researches the advertising to help users assess the legitimacy of the advertising; d. classifying an email advertisement as legitimate or illegitimate; e. labeling, encoding, or otherwise marking the email advertising with its classification as legitimate or illegitimate; f. posting advertisement classifications in a public web site; g. making available through a public web site advertisements that are certified or otherwise classified as legitimate; h. blocking from a user's email inbox advertisements that are not certified or otherwise classified as legitimate; and i. publicizing research results.

This application claims the benefit under 35 USC 119 of priority to U.S. provisional patent application Ser. No. 60/538,885 filed Jan. 23, 2004.

One embodiment of the invention relates to a new email service provider which has features/functions that can also be available in a software form/version that can be downloaded and implemented/used by consumers or businesses with existing email services. Suitable features/functions for the inventive embodiment(s) include a service/device/system that quickly and efficiently:

1) Effectively opts consumers out of unwanted or unsolicited email advertisements (commonly called “spam”) (a.k.a. Internet Offers) which they receive in their email inboxes.

2) Attempts to contact the company promoting the product or service in the spammed advertisement. This can be done via phone, fax, email, direct response to the Online Ad, direct mail and/or any other means of contact determined to be effective or worth trying. The inventive embodiment may then seek to research, investigate, and ultimately find out the background, accuracy and legitimacy of such advertisements and companies promoting such advertisements.

3) Posts some or all of the information found or not found during this research process to the public, in an effort to better inform and educate consumers about the advertisements they receive. This may benefit consumers by a) saving them time spent accessing, reviewing and researching internet offers on their own, b) reducing consumer frustration experienced while sifting through advertisements that are often misleading and confusing; and/or 3) helping consumers avoid being wronged and deceived by fraudulent and deceptive advertisements.

The invention may help decrease the amount of spam people receive and enable people to be better educated when deciding whether or not to go ahead and pursue any Internet advertisement. This could result in less wasted time spent dealing with spam and less people getting mislead, confused and otherwise wronged from the ever growing number of email advertisements they receive and will continue to receive.

An embodiment of the invention in software or an email service, for instance, could help consumers by featuring a NEW “Opt-Out-Delete” button option they can click in addition or as opposed to the current “Delete” button currently used in email services. The button could also be called “MARK Delete”, “forward delete” or “DeletePlus”, where MARK denotes or represents the use of an authorized trademark and/or service mark. When consumers click this new button instead of their current Delete button, in some embodiments as many as three actions could happen in that one single click, such that consumers get less spam in the future and are able to access valuable background information about these advertisements as well as other advertisements “opt out deleted” by them and similar consumers using the invention. In other embodiments, additional actions and/or a subset of these actions occur. The three actions are:

1) The email gets deleted.

2) The email gets forwarded to a research/facilitation site to be background checked and researched.

3) The recipient/consumer is “Opted Out” of the advertisement offer.

The following is a detailed description of the functionality and step-by-step process of using the new “opt out delete” button and the results experienced by using it:

1) An authorized entity creates its own NEW email service provider (according to the invention) where consumers will be able to take advantage of the new “opt out delete” button.

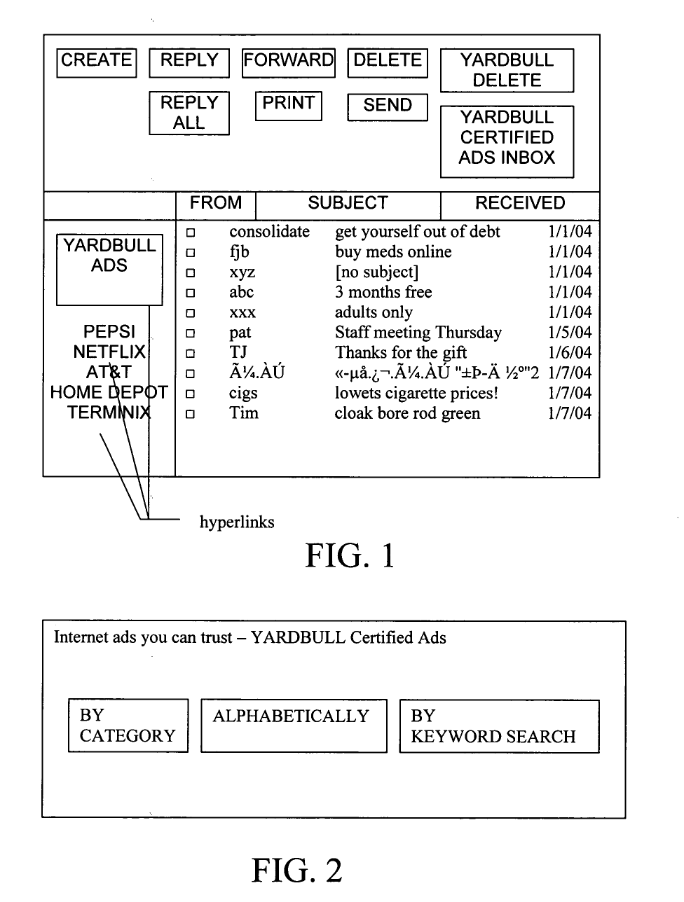

When a consumer is using an email account according to one embodiment of the invention, the consumer will find a NEW button on the interface possibly called “opt out delete”, “deleteplus”, “MARKdelete”, or “forwarddelete” in addition to their current normal buttons including their normal delete button. One suitable interface is shown in a diagram in FIG. 1 (marks shown therein belong to their respective owners). In FIG. 1, the YARDBULL ADS button is a hyperlink to YardBullAds.com (for instance), which site then presents users with an interface like the one shown in FIG. 2. In FIG. 1 the example hyperlinks shown under the YARDBULL ADS button hyperlink are hyperlinks to specific ads at the YarBullAds.com site, e.g., certified ads from the vendor in question. The YARDBULL CERTIFIED ADS INBOX brings up an inbox view similar to the one illustrated in FIG. 1, but the inbox contains only certified ads.

When consumers click the YARDBULL DELETE button (under whatever name), the following will happen as a result of that one simple click:

1) The email gets deleted.

2) The email gets forwarded to an authorized entity to be background checked and researched.

3) The recipient/consumer is “Opted Out” of the advertisement offer.

Once that button is clicked, the “opt out deleted” or “MARKDeleted” email is automatically forwarded to a database forming part of the invention and automatically deleted from the consumer's inbox. One MARK currently contemplated is YARDBULL but it is understood that the choice of trademark(s) or service mark(s) used with embodiment(s) of the invention is not dictated by, nor limiting of, the invention.

When the forwarded email is received by, e.g., an authorized entity at YardBull.com, the mail is either automatically (technologically) or immediately manually taken through the process of being “Opted Out” or “unsubscribed” from the sender's mailing lists, which may make it illegal in some jurisdictions for the sender to send future advertisements. During the manual opt out process the authorized entity could use batching technology to quickly opt out different consumers out of the same offer and then batch the opt outs over to the company that sent the spam so they all get Opted Out together at once. Once this process is complete it is illegal (at least under the inventor's understanding of the United States federal Can Spam Act of 2003) for the list owner to send future advertisements to this consumer's email address.

Once the authorized entity has received forwarded advertisements from consumers, it will begin the process of attempting to contact each company representing the products and/or services being advertised (spammed). Once contact is made the authorized entity will invite the company to MARK-certify their advertisements being promoted on the Internet. To become a MARK-certified advertisement the company must complete a MARK-certification application either over the phone or electronically. The MARK used in the certification may be the same or different from the MARK used in email programs embodying the invention. Indeed, a mark may be used in either, both, or neither case; use of marks is not a required element of the invention as currently contemplated. The MARK-certification application may ask one or more of the following questions regarding the company applying for certification:
1) Physical address of business, mailing address, shipping address
2) All phone numbers including fax
3) Links to various public agencies that publish consumer feedback like BBB, JD Power and associates, the rip off report, consumer reports . . . etc
4) Any customer feedback/comments . . . negative or positive
5) Fed Tax ID number
6) Business License #
7) Number of years in business
8) Consumer Testimonials
9) Sales revenues
10) Lawsuits, disputes, settlements
11) Names of officers of company
12) Legal name of business, D.B.A.'s
13) What products do you sell. List all
14) What services do you provide. List all.
15) Business references and referrals
16) Review the CAN spam act laws with the company for compliance
17) Does the company offer a guarantee or return policy for their products and/or service(s)? What is it?

Once any company (being forwarded through the invention email service/software or finding the authorized entity by any other means) has successfully cleared the certification process, they will be able to place a “MARK certified ad” trademark symbol on their advertisement and be invited to become an advertising partner with, e.g., YardBullAds.com, where the advertisement will then be posted on, e.g., YardBullAds.com, for the public to access. At this time the authorized entity may attempt to negotiate an advertising contract with the certified company, which contract may include the placement/use of the, e.g., YARDBULL CERTIFIED ADS trademark symbol on approved advertisements cleared by the authorized entity in advance. Such approval determinations/criteria may include but not be limited to examining:
1) Straightforwardness of the Ad
2) Clarity of the message being sent in the Ad
3) Vulgar or offensive material in the Ad
4) Misleading information or extraordinary and unrealistic claims

YardBullAds.com, for instance, would be a site where anyone can go to find certified ads of companies successfully completing the certification process. At this or another authorized entity website, consumers will be able to search for various ads either by category, alphabetically, or by keyword search, for instance. They may also view ads as they appear on the site. YardBullAds.com, for instance, may list advertisements using graphics, one liners clearly describing the offer and other means to promote the certified ads in a straightforward way to consumers and give them the opportunity to access certified advertisers' websites, lead forms, links, and other information with confidence, being more knowledgeable about advertising offers and companies that promote them. All certified ads could be listed with the background information acquired by the authorized entity during the certification process. The authorized entity may or may not choose to list all the information initially received from the advertiser through the certification process.

Non-certified ads may also be listed on, e.g., YardBullAds.com, with reasons why the authorized entity did not certify them and possibly other information found during the background check that consumers could find useful and informative. Non-certified ads may include, e.g., ads from companies promoting ads that didn't wish to go through the certification process, failed the certification process or started the application process but left it incomplete. In one embodiment the non-certified ads will not be accessible for the public to (i) be able to click through, (ii) follow a linked to their home page, or (iii) otherwise pursue them, unlike the way they could with the certified ads found on the site. For non-certified ads, YardBullAds.com (for instance, or another authorized site) is a place that simply posts what the authorized entity was or was not able to find out about the company/ad and why it was not able to be certified. For certified ads YardBullAds.com could be a place where consumers can find real companies with real products and/or services that are legitimate and clear to understand. YardBull-certified ads could also provide consumers with background info and links to access more information about the company and the advertisements they are offering. Any company advertising with YardBullAds.com through a Yard Bull certified ad is more likely to be promoting advertising without annoying or misleading techniques to deceive consumers. Companies that are YardBull certified will therefore be more likely to ultimately win the business of loyal YardBull consumers because their product or service will be exposed to loyal YardBull consumers who (it is contemplated) will trust the YardBull certified symbol and be seriously shopping for legitimate products and services.

Another feature found at some embodiments of a site such as YardBullAds.com is a listing of ads that the authorized entity selects in an attempt to identify or create unique, different or noticeable trends. For example, an authorized entity may post a list of ads that seem to be frequently “YardBulldeleted” and consequently opted out and yet the ad still keeps coming back to the same email addresses. The authorized entity could post a list of these ads and create a “top ten most wanted spam ads” list in an effort to expose abusers of the Can Spam Act or other laws by failing to remove consumers and stop sending ads to consumers who have requested the Opt Out and continue to send ads anyway. The authorized entity may seek to work with governmental agencies and/or companies or individuals seeking to prosecute can spam abusers or other wrongdoers by providing such information that may be helpful in those efforts. The authorized entity may also list and rank ads that have high consumer ratings and ads that consumers recommend for various reasons from personal experience. Conversely, a site such as YardBullAds.com may post and rank ads that consumers have had negative experiences with. Other lists and ranking similar to these that could be educational, protective and/or otherwise helpful to consumers regarding pursuing advertisements found in email or anywhere else on the Internet may also be added to sites like YardBullAds.com from time to time.

In some embodiments, sites like YardBullAds.com offer various levels of advertising exposure to advertising partners. Companies advertising with an authorized entity will be able to, for a price, receive more or less rotation exposure, have their ad placed with higher or lesser priority, increase or decrease the graphic/logo sizes and text/character limits on their ads and other advertising choices relating to the cost of advertising as they are developed by sites like YardBullAds.com

YardBullAds.com and/or other sites according to the invention may be accessible from the inventive email service or the inventive software. Consumers can then easily go from using their email at the invention to viewing advertisements found at YardBullAds.com through a direct, always visible link. Also, certified advertisers that meet a high level consumer favorability can be posted, for a price paid to the authorized entity, and advertised on the inventive email service for consumers to be able to hyperlink directly to that particular certified ad found on YardBullAds.com

In some embodiments, the inventive email service provides its users an assurance that any certified ad with the MARK certified symbol on it will not be allowed (barred technologically by, e.g., filtering) to enter the main inbox of any MARK email account. In some embodiments, the inventive email service provides its users an assurance that any ad without the MARK certified symbol on it will not be allowed to enter the main inbox of any MARK email account. In some embodiments, any ad with the MARK certified symbol on it will be allowed to enter the main inbox of any MARK email account. In some embodiments, any ad without the MARK certified symbol on it will be allowed to enter the main inbox of any MARK email account.

As time goes by and more spam ads get “YardBulldeleted” (for instance) by growing numbers of email users, more ads will consequently get “YardBullcertified” (for instance). The non-certified ads will not be able to enter the main inboxes of YardBull™ email users because they will be scanned, e.g., for the YardBull certified symbol on the ad, and be re-routed as they try to enter the inbox.

In some embodiments, the invention will also create a new email button such as a new “CertifiedAdsYardBullInbox” button where YardBull™ users can click and choose to receive YardBull-certified ads, which are sent to them and collected separately in, e.g., a CertifiedAdsYardBulllnbox so that they can access and review them later at their leisure without interrupting or clogging up their main inbox. This process keeps the YardBull-certified ads out of the consumer's main inbox and places them in the new CertifiedAdsYardBulllnbox where they can choose to view only YardBull-certified ads that they can trust and know have been researched, background-checked and thus will not be as likely to be a waste of time for them to pursue and are likely to be less risky. Of course, in some embodiments YardBull™ users can at any time go directly to YardBullAds.com to view all ads that have ever been “YardBullDeleted” by any YardBull™ user, to view certified and/or non-certified ads.

In some embodiments, the invention may also allow users to choose another feature that allows, e.g., YardBull-Certified Ads into their main inbox with technology that pre-checks (checkmarks) non-certified ads, without the YardBull certification symbol, so they are quickly noticeable and easy to delete or “YardBullDelete”. This could operate in conjunction with email code that deletes all checked messages. This would allow consumers the ability to view the YardBull-certified symbol right on the ad in their main inbox and “cherry pick” them.

The inventor's idea and belief is that if everyone was using the invention as their email service, then all businesses would eventually decide to use it as well because eventually all the ads would come through an inventive system where they would be effectively opted-out and then either become labeled a certified or non-certified advertisement. As more and more consumers used the invention and more businesses become certified or non-certified, consumers using the invention would be receiving less and less spam and have less clogged inboxes. The actions of fellow users who are also “YardBullDeleting” spam will tend to decrease the amount of spam for all users of the system—users of the invention help each other reduce spam when using the inventive email service.

As for the non-certified ads, which are basically every ad that is “YardBullDeleted” but not YardBull certified, these ads will by default be added to YardBull's database of ads that are used to block the same incoming ads to any user of the invention. This can be a powerful mechanism because even if only one use of the invention “YardBullDeletes” an ad that ends up becoming a non-certified YardBull ad, then YardBull will use specific pieces of information from that particular ad to scan against future spam and not allow it to enter the email inbox of any user of the invention, because it a non-certified ad. It has already been Opted Out by one user of the invention and consequently is labeled as a non-certified ad for various reasons, and hence will be scanned against to prevent it from entering user's inbox. A YardBull authorized entity could use specific keywords/names found in the original spammed ad to identify future incoming ads matching the original spammed ad as a “non-certified” YardBull ad so it can be effectively blocked, such as, but not limited to:
1) The company name of the non-certified ad
2) The product brand name of the non certified ad
3) The service brand name of the non certified ad
4) The IP addresses the non certified ad was sent from
5) A persons name representing a non certified ad

This illustrates the potential power of an inventive feature such as the “YardBullDelete” button, with regard to a given user and to all users of the invention. As fellow users “YardBullDelete” the ads, they will either become labeled as YardBull Certified or YardBull non-certified ads once and for all. Both categories of ad have their own future blocking mechanisms that will keep them out of the invention users' main email inboxes. Ads in either category may be posted at YardBullAds.com: the YardBull Certified ads will be able to, by user choice, be sent to user's “CertifiedAdsYardBulllnbox”. The non-certified ads get blocked as best one can, using filters and other blocking tools and techniques from the current spam blockers, supplemented by data identifying non-certified ads. The non certified ads that continue to slip through will tend to gather extra attention and begin to surface to the top as among the internet's most abusive spam advertisements and will be dealt with as such.

Eventually authorized entities operating according to the invention will have collected a large database of ads; indeed, they might obtain a copy of every advertisement being spammed through email, though that is not necessary for the invention to operate. They could also collect all the new spam created on an ongoing basis. After going through the YardBull process, each ad will either become a YardBull certified ad (corresponding to one or more possible advertising partners) or a YardBull Non certified ad that is blocked and discouraged from consumers. At this point the consumers are reducing the amount of spam because they have opted out of spammed non-certified ads, helping each other by “YardBullDeleting” their spam thereby separating the certified ads from the non certified ads and highlighting companies with nothing to hide—those having real products and real services to offer the public and legitimate, straightforward ads as certified and consumers know where to find them, when they want to find them without wasting time and money going through the trial and error, hassle and lost money and can finally have confidence and trust when making decisions to respond to, pursue and access internet ads.

The more consumers use the invention, the less power spam will tend to have, because advertisers will realize that their money is not being spent wisely and their return on their investment is reducing and they will be more likely to choose to become YardBull certified and get the “eyeballs” that way instead of spamming. Their advertising dollars spent with YardBull will result in less complaints and better quality customers as more mainstream people look to spend real money on real products and services use YardBull to find what they are looking for because of their trust and confidence in it.

Note that in the preceding paragraph, as elsewhere in this patent document, the mark YardBull is used to identify a specific contemplated embodiment of the invention. The embodiment is specific in that it will be provided in connection with the YardBull mark(s). Those marks are thus not used here in a generic sense, but instead in an illustrative one. The invention is not limited to embodiments that are connected with the YardBull mark, or with any particular mark; rather, the scope of the invention under patent laws corresponds to the advancing utilitarian or technical (as called for by the patent jurisdiction in question) features, processes, combinations, and other innovations described here. YardBull will continue to be used here in examples, subject to these comments.

2) YardBull will create software featuring the “YardBullDelete” function/feature option that can be downloaded by anyone and is compatible with already existing email providers, enabling people to use YardBull service and features without having to change their email address.

This software could be downloaded directly from the Internet or obtained on a CD-ROM, for instance. This software would make all of the features and functions of the invention's email account available to someone using other email services simply by downloading the YardBull software to their current email applications. It could be a snap-in or plug-in to email such as QualComm's Eudora program, Microsoft's Outlook program, or other stand-alone email, or to web-based email services like those provided by ISPs, AOL, Yahoo!, and so on.

With the invention, potential customers include those who use email and want less spam and/or anyone who wants to be better educated and more informed about the ads they see on the Internet before spending valuable time sifting through the often confusing and misleading ads and researching the companies representing the products and services.

The invention could also be valuable to businesses with employees who lose/waste valuable time during work “dealing” with spam.

The invention has various possible ways to reach potential customers. They include, for instance:

1) Creating its own FREE email Service featuring the NEW “YardBullDelete” button function/feature option.

2) Creating software featuring the NEW “YardBullDelete” function/feature option that can be downloaded by anyone and is compatible with already existing email providers, enabling people to benefit from the YardBull service without having to change their email address.

3) Mass marketing, TV and word of mouth of these services to reach the masses.

Authorized entities seeking to commercialize the invention could seek investors, both private and from V.C. groups to get the financial resources to start their business.

In time, it is hoped that any consumer who sees the trademarked YardBull Certified Ad symbol on any advertisement found anywhere on the Internet will feel more comfortable and confident about the advertisement and feel like they have a better educated starting point when trying to decide whether or not to pursue any particular ad they come across on the Internet because of the trusted YardBull symbol.

YardBull Advertising Network (YBAN.com)

As YardBull (for instance) adds more and more YardBull Certified Advertising Partners, it may seek to make these ads available to legitimate advertising publishers who are interested in promoting the certified ads on their websites and to their customer databases. They would only be able to promote advertisements that are YardBull certified and could be allowed and required to place the trademarked YardBull Certified Ad symbol clearly on all their advertising creatives. Activities and publications which one any “affiliate” or “publisher” intends to use to advertise YardBull advertisements would need to be approved in advance by YardBull. One suitable interface for an advertisements site according to the invention is shown in FIG. 2.

Additional Features for YardBull.com

When YardBull.com (for instance) receives forwarded emails such as those that have been YardBullDeleted, the authorized service entity at that site may attempt to label all ads as certified or non certified. Personal, business, or any other correspondence that is received and not found to be an email seeking to sell, advertise or otherwise be promoting will not be “labeled” but instead be rather discarded and never disclosed.

During the research and background check process performed by YardBull.com when it receives forwarded “YardBullDelete”d emails from consumers, YardBull.com will additionally seek to find out and/or verify and/or confirm the following exemplary research information, which it may or may not choose to post, report or otherwise make available to consumers and/or the government, other countries or anyone else:

1) Whether the opt-out link provided by the (sender) company, person, or third party who sent the original spam works or doesn't work (really opts them out or not) and also was deceptive or not. This includes finding out if the link is confusing and/or is difficult in any way to complete or accomplish. YardBull.com will also follow up with the “sender” of the spam to make sure they honor the opt-out choice of the consumer within 10 days or other period specified by applicable law.

2) Whether or not the original spam was sent from an accurate address.

3) Whether or not the original spam contained sexually explicit material presented to the recipient simply by opening the e-mail.

4) Whether or not the original spam contained a standardized warning label indicating that it contained sexually explicit material inside.

5) Whether or not the subject lines in the forwarded spam ads were deceptive.

6) Whether or not the apparent ad source in the from line in the spam ad is deceptive.

7) Whether or not the original spam was sent from a disguised email origin with false routing information.

8) Whether or not they are sending mail from the within the USA? If not, what country? And are they are a company located in the USA or not?

YardBull.com may or may not choose to guarantee YardBull users to have the entire process from “YardBullDelete”, opting them out . . . . etc to posting ads at YardBullAds.com for public view within 10 days from when the consumer initially clicked the YardBullDelete” button. This would be consistent with the CAN Spam act.

YardBull.com, may entertain requests from other groups, companies or organizations to find out new or additional information during the certification process.

YardBull.com may choose to implement the use of the standardized warning label device, for filtering out sexually explicit material, to be used as criteria for labeling non-certified YardBull ads that can be consequently blocked from any fellow YardBull.com user's accounts/service. This label will additionally help the blocking process of non-certified ads from all YardBull.com users since any advertisement containing sexually explicit material could automatically be considered a non-certified ad, labeled as such and effectively blocked from YardBull.com users along with the other ads labeled as such through the YardBull certification process.

YardBull.com may or may not choose to be able to allow its users the option to choose to accept or block any ads containing the standardized warning label device, filtering out sexually explicit material, for themselves.

YardBull.com may seek to cooperate, work with and further contemplate its relationship with one or more appropriate governmental agencies or officials, in one or more countries, and with other groups or individuals in partnering to provide helpful information that it finds during its business activities. This includes any information about persons, companies and other “senders” of email that it finds to be possibly doing so illegally and will furthermore prove helpful in the overall fight against un-lawful spam and sexually explicit material/ads and other offensive material being spammed through email and/or otherwise found on the internet.

YardBull.com may choose to forward any ads or information it finds or suspects to be illegal to the government (e.g., to uce@ftc.gov), to officials in various countries, and/or anywhere else that might prove to be valuable and/or useful in the fight against spam.

YardBull.com may also choose to work with local and national media sources like TV, radio, cable, satellite, email, internet and any other means it chooses to broadcast any of its findings to the public so that consumers can be better informed about who is breaking the law and what consumers can do to help solve/reduce the problem.

YardBull.com will use all of the information it finds out, collects, discovers and otherwise acquires through the entire “YardBullDelete”, opt-out, background check, investigation, certification, forwarding process and/or any other way any information is received to build a master database containing files of all the information. This information may be extremely valuable for product/service, company, content and other statistical information that could be used for future marketing and information purposes.

The following are possible marketing and sales strategies regarding YardBull.com that could be used to promote the service to consumers and businesses:

1) YardBull.com can decrease the time wasted on deleting, opting out, forwarding and other “clicking” to get rid of spam. If you add up the time it takes an average person to see, open, click on, enlarge, scroll down, click opt out, type in your email address to finish the opt out process, forward the email to “authorities”, close the window, and go back to your inbox, and then compare that to YardBull.com's one simple “YardBullDelete” click that accomplishes all of those things in just seconds, you could save yourself a weeks or months of time, and you will also be instrumental in reducing spam.

2) If you use YardBull.com, not only will you receive less spam and know which Internet ads are legitimate and valid, but you will join the force of consumers that will eventually significantly reduce spam (maybe crush it altogether) and help prosecute those who continue to promote it illegally.

For businesses, YardBull.com will provide features within the software that allow the company and its employees to KEEP their same corporate email accounts but be able to use/have access to all the features of a typical YardBull.com account without having to change their company accounts or use the YardBull name within their employees/officers email addresses, making the process simple and calm. This could be valuable to businesses as they seek to decrease spam in the workplace and increase employee productivity.

### FURTHER EXAMPLES

1. The invention provides a method for a recipient to respond to email advertising that is unwanted by using a single action, such as a button press, to both delete the advertising and opt the user out of the advertising. Opting out may be done by sending an email to an opt-out link or address provided in the unwanted advertising. Alternately, it may be done by forwarding a copy of the unwanted advertising to an opt-out service, which automatically and/or manually parses the message to locate the opt-out address or link, and sends an opt-out message on behalf of the user who forwarded the advertising to the opt-out service. Alternately, messages that are not affirmatively retained may be opted-out and deleted after some specified time and/or after a specified user action pertaining to multiple messages, such as a command to “perform mailbox maintenance”.

2. Indeed, the invention provides a number of distinct but closely related methods for dealing with unwanted email advertising, such as methods that contain at least any two or more of the following steps:
a. deleting unwanted email advertising;
(such deleting performed, e.g., by software at a recipient user's request and site);
b. automatically opting-out of unwanted email advertising (which could include, e.g., parsing the unwanted email to find an opt-out address or link, creating an opt-out email request to provide the email address of the recipient of the unwanted email so that email address can be taken off email advertising mailing lists, and sending the opt-out email request to the opt-out address or link);
(such opting-out performed, e.g., by software at a recipient user's request and site, or by a service to which the recipient user site forwards the advertising);
c. semi-automatically opting-out of unwanted email advertising, that is, opting-out in a partially automated manner, e.g., by having a person read the advertising to determine alleged contact information of the advertiser, having the person enter that alleged contact information by typing or cut-and-paste into an opt-out form, automatically determining the user email address and automatically entering that in the opt-out-form, automatically generating an opt-out email request from the data in the form;
(such opting-out performed, e.g., by software at a recipient user's request and site, or by a service to which the recipient user site forwards the advertising);
d. forwarding unwanted email advertising to a service which opts-out users;
(such forwarding performed, e.g., by software at a recipient user's request and site);
e. forwarding unwanted email advertising to a service which researches the advertising to help users assess the legitimacy of the advertising according to specified criteria, such as objective criteria (e.g., does the advertiser have a physical address and phone number, does the advertiser respond when contacted with a request for it's federal tax ID, etc.) and/or subjective criteria (e.g., is the advertising vulgar, is it confusing, does the content of the advertising match the subject line, does the ad contain sexually explicit material, etc.);
(such forwarding performed, e.g., by software at a recipient user's request and site);
f. receiving forwarded mail and examining it initially only to the extent needed to determine whether it is advertising, and discarding it in a manner that maintains confidentiality if it is not advertising;
g. researching the advertising to help users assess the legitimacy of the advertising according to specified criteria;
(such researching performed, e.g., at the service's site in response to receiving forwarded email advertising)
h. researching that may include, e.g., research into databases and contact with people such as: questions regarding the company applying for certification, determinations/criteria such as straightforwardness, clarity, vulgarity of an ad; exemplary research information, which it may or may not choose to post, report or otherwise make available;
i. classifying an email advertisement as legitimate or illegitimate based on the results of such researching;
j. labeling, encoding, or otherwise marking the email advertising with its classification (legitimate or illegitimate), e.g., by embedding a string or symbol or graphic or logo (which might be a protected trademark) in the email advertising, e.g., in the subject line or the body of the advertising message;
k. posting advertisement classifications (and perhaps also their basis for classification, e.g., “no working phone number” or “company listed by Better Business Bureau”) in a public web site;
l. making available through a public web site advertisements that are certified or otherwise classified as legitimate;
m. blocking from a user's email inbox advertisements that are not certified or otherwise classified as legitimate;
n. providing illegitimate advertising to a governmental authority;
o. providing research results to a governmental authority;
p. publicizing research results.

Note that method steps may be computer-implemented, e.g., performed under software control once the initial command is given by a user. Alternately or in addition, method steps may be computer-assisted, e.g., performed with a mixture of software operations and intervening human-performed steps, as when email is parsed both by software and by having a person read it to obtain information (alleged company name, alleged company contact info such as phone number and address, apparent opt-out link, and so on).

Suitable software to assist in implementing the invention is readily provided by those of skill in the pertinent art(s) using the teachings presented here and programming languages and tools such as C++, C, Java, APIs, SDKs, assembly, firmware, microcode, and/or other languages and tools.

3. Note also that the invention is not limited to methods. Although particular embodiments of the present invention such as particular methods are expressly illustrated and described individually herein, it will be appreciated that discussion of one type of embodiment also generally extends to other embodiment types. For instance, the description of the methods also helps describe systems and devices, and vice versa. The invention also provides a computer-readable medium (e.g., memory stick, removable disk, CD, hard disk, RAM, ROM, ASIC, FPGA) configured with software which performs or assists in performing one or more of the methods described here. The invention also provides a computer system configured with software and hardware which performs or assists in performing one or more of the methods described here. The invention may also be adapted for use with so-called “spim”, that is, spam sent via instant messaging.

### CONCLUSION

In short, one summary of an embodiment of the invention is that it is a method or a computer-aided/implemented system for reducing unsolicited email advertising by providing a convenient way to classify ads as certified or not according to indicia related to the reliability and legitimacy of their source, to view certified ads, to block noncertified ads, and/or to forward unclassified ads to a classifier and delete them from one's own mailbox. This invention therefore relates to one or more of: Classifying ads as legitimate or illegitimate; viewing legitimate ads; blocking illegitimate ads; and/or conveniently forwarding unclassified ads to a classifier, opting out, and deleting them.

As a specific example, one method of the invention comprises performing, in response to a single command of a user, at least two of the following steps: deleting an unsolicited email advertisement from the user's email box; forwarding a copy of the unsolicited email advertisement to an authorized entity for further processing; opting-out the user using data in the unsolicited email advertisement. In such a method, the further processing step, if present, may include researching the source of the unsolicited email advertisement and/or other steps, and in particular may include opting-out the user using data in the unsolicited email advertisement if that was not already done.

1. A method for dealing with unwanted email advertising, comprising at least two of the following steps:
a. deleting unwanted email advertising;
b. automatically opting-out of unwanted email advertising;
c. semi-automatically opting-out of unwanted email advertising;
d. forwarding unwanted email advertising to a service which opts-out users;
e. forwarding unwanted email advertising to a service which researches the advertising to help users assess the legitimacy of the advertising;
f. receiving forwarded mail and examining it initially only to the extent needed to determine whether it is advertising, and discarding it in a manner that maintains confidentiality if it is not advertising;
g. researching the advertising to help users assess the legitimacy of the advertising according to specified criteria;
h. researching into databases and contact with people;
i. classifying an email advertisement as legitimate or illegitimate based on the results of such researching;
j. labeling, encoding, or otherwise marking the email advertising with its classification as legitimate or illegitimate;
k. posting advertisement classifications in a public web site;
l. making available through a public web site advertisements that are certified or otherwise classified as legitimate;
m. blocking from a user's email inbox advertisements that are not certified or otherwise classified as legitimate;
n. providing illegitimate advertising to a governmental authority;
o. providing research results to a governmental authority;
p. publicizing research results.
